(19) United States
(12) Patent Application Publication
(10) Pub. No.: US 2009/0177479 A1
(43) Pub. Date: Jul. 9, 2009

(54) Method for Encoding and Decoding Object-Based Audio Signal and Apparatus Thereof

(75) Inventors: Sung Yong Yoon, Seoul (KR); Hee Suk Pang, Seoul (KR); Hyun Kook Lee, Kyunggi-do (KR); Dong Soo Kim, Seoul (KR); Jae Hyun Lim, Seoul (KR)

Correspondence Address: FISH & RICHARDSON P.C., PO BOX 1022, MINNEAPOLIS, MN, 55440-1022, US

(73) Assignee: LG ELECTRONICS INC., Seoul (KR)

(21) Appl. No.: 12/278,777

(22) PCT Filed: Feb. 9, 2007
(86) PCT No.: PCT/KR2007/000730

§ 371 Date: Aug. 7, 2008

Related U.S. Application Data
(60) Provisional application No. 60/771,471, filed on Feb. 9, 2006.
(60) Provisional application No. 60/773,337, filed on Feb. 15, 2006.

(51) Int. Cl. G10L 21/00

(52) U.S. Cl. 704/500; 704/E19.001

(57) ABSTRACT

Methods and apparatuses for encoding and decoding an object-based audio signal are provided. The method of decoding an object-based audio signal includes extracting a down-mix signal and object-based parameter information from an input audio signal, generating an object-audio signal using the down-mix signal and the object-based parameter information, and generating an object audio signal with three-dimensional (3D) effects by applying 3D information to the object audio signal. Accordingly, it is possible to localize a sound image for each object audio signal and thus provide a vivid sense of reality during the reproduction of object audio signals.

### TECHNICAL FIELD

The present invention relates to methods and apparatuses for encoding and decoding an audio signal, and more particularly, to methods and apparatuses for encoding and decoding an audio signal which can localize a sound image in a desired spatial location for each object audio signal.

### BACKGROUND ART

In general, in a typical object-based audio encoding method, an object encoder generates a down-mix signal by down-mixing a plurality of object audio signals and generates parameter information including a plurality of pieces of information extracted from the object audio signals. In a typical object-based audio decoding method, an object decoder restores a plurality of object audio signals by decoding a received down-mix signal using object-based parameter information, and a renderer synthesizes the object audio signals into a 2-channel signal or a multi-channel signal using control data, which is necessary for designating the positions of the restored object audio signals.

However, the control data is simply inter-level information, and there is a clear limitation in creating 3D effects by performing sound image localization simply using level information.

### DISCLOSURE OF INVENTION

### Technical Problem

The present invention provides methods and apparatuses for encoding and decoding an audio signal which can localize a sound image in a desired spatial location for each object audio signal.

### Technical Solution

According to an aspect of the present invention, there is provided a method of decoding an audio signal. The method includes extracting a down-mix signal and object-based parameter information from an input audio signal, generating an object-audio signal using the down-mix signal and the object-based parameter information, and generating an object audio signal with three-dimensional (3D) effects by applying 3D information to the object audio signal.

According to another aspect of the present invention, there is provided an apparatus for decoding an audio signal. The apparatus includes a demultiplexer which extracts a down-mix signal and object-based parameter information from an input audio signal, an object decoder which generates an object-audio signal using the down-mix signal and the object-based parameter information, and a renderer which generates a three-dimensional object audio signal with 3D effects by applying 3D information to the object audio signal.

According to another aspect of the present invention, there is provided a method of decoding an audio signal. The method includes extracting a down-mix signal and object-based parameter information from an input audio signal, generating channel-based parameter information by converting the object-based parameter information, generating an audio signal using the down-mix signal and the channel-based parameter information, and generating an audio signal with 3D effects by applying 3D information to the audio signal.

According to another aspect of the present invention, there is provided an apparatus for decoding an audio signal. The apparatus includes a demultiplexer which extracts a down-mix signal and object-based parameter information from an input audio signal, a renderer which withdraws 3D information using index data and outputs the 3D information, a transcoder which generates channel-based parameter information using the object-based parameter information and the 3D information, and a multi-channel decoder which generates an audio signal using the down-mix signal and the channel-based parameter information and generates an audio signal with 3D effects by applying 3D information to the audio signal.

According to another aspect of the present invention, there is provided an apparatus for decoding an audio signal. The apparatus includes a demultiplexer which extracts a down-mix signal and object-based parameter information from an input audio signal, a renderer which withdraws 3D information using input index data and outputs the 3D information, a transcoder which converts the object-based parameter information into channel-based parameter information, converts the 3D information into channel-based 3D information and outputs the channel-based parameter information and the channel-based 3D information, and a multi-channel decoder which generates an audio signal using the down-mix signal and the channel-based parameter information and generates an audio signal with 3D effects by applying the channel-based 3D information to the audio signal.

According to another aspect of the present invention, there is provided a method of encoding an audio signal. The method includes generating a down-mix signal by down-mixing an object audio signal, extracting information regarding the object audio signal and generating object-based parameter information based on the extracted information, and inserting index data into the object-based parameter information, the index data being necessary for searching for 3D information which is used to create 3D effects for the object audio signal.

According to another aspect of the present invention, there is provided a computer-readable recording medium having recorded thereon a program for executing one of the above-mentioned methods.

### ADVANTAGEOUS EFFECTS

As described above, according to the present invention, it is possible to provide a more vivid sense of reality than in typical object-based audio encoding and decoding methods during the reproduction of object audio signals by localizing a sound image for each of the object audio signals while making the utmost use of typical object-based audio encoding and decoding methods. In addition, it is possible to create a high-fidelity virtual reality by applying the present invention to interactive games in which position information of game characters manipulated via a network by game players varies frequently.

### BRIEF DESCRIPTION OF THE DRAWINGS

FIG. 1 illustrates a block diagram of a typical object-based audio encoding apparatus;

FIG. 2 is a block diagram of an apparatus for decoding an audio signal according to an embodiment of the present invention;

FIG. 3 illustrates a flowchart illustrating an operation of the apparatus illustrated in FIG. 2;

FIG. 4 illustrates a block diagram of an apparatus for decoding an audio signal according to another embodiment of the present invention;

FIG. 5 illustrates a flowchart illustrating an operation of the apparatus illustrated in FIG. 4;

FIG. 6 illustrates a block diagram of an apparatus for decoding an audio signal according to another embodiment of the present invention;

FIG. 7 illustrates the application of three-dimensional (3D) information to frames by the apparatus illustrated in FIG. 6;

FIG. 8 illustrates a block diagram of an apparatus for decoding an audio signal according to another embodiment of the present invention; and

FIG. 9 illustrates a block diagram of an apparatus for decoding an audio signal according to another embodiment of the present invention

### BEST MODE FOR CARRYING OUT THE INVENTION

The present invention will hereinafter be described more fully with reference to the accompanying drawings, in which exemplary embodiments of the invention are shown.

Methods and apparatuses for encoding and decoding an audio signal according to the present invention can be applied to, but not restricted to, object-based audio encoding and decoding processes. In other words, methods and apparatuses for encoding and decoding an audio signal according to the present invention according to the present invention can also be applied to various signal processing operations, other than those set forth herein, as long as the signal processing operations meet a few conditions. Methods and apparatuses for encoding and decoding an audio signal according to the present invention according to the present invention can localize sound images of object audio signals in desired spatial locations by applying three-dimensional (3D) information such as a head related transfer function (HRTF) to the object audio signals.

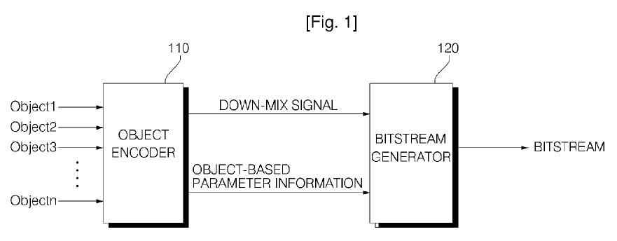

FIG. 1 illustrates a typical object-based audio encoding apparatus. Referring to FIG. 1, the object-based audio encoding apparatus includes an object encoder 110 and a bitstream generator 120.

The object encoder 110 receives N object audio signals, and generates an object-based down-mix signal and object-based parameter information including a plurality of pieces of information extracted from the N object audio signals. The plurality of pieces of information may be energy difference and correlation values.

The bitstream generator 120 generates a bitstream by combining the object-based down-mix signal and the object-based parameter information generated by the object encoder 110. The bitstream generated by the bitstream generator 120 may include default mixing parameters necessary for default settings for a decoding apparatus. The default mixing parameters may include index data necessary for searching for 3D information such as an HRTF, which can be used to create 3D effects.

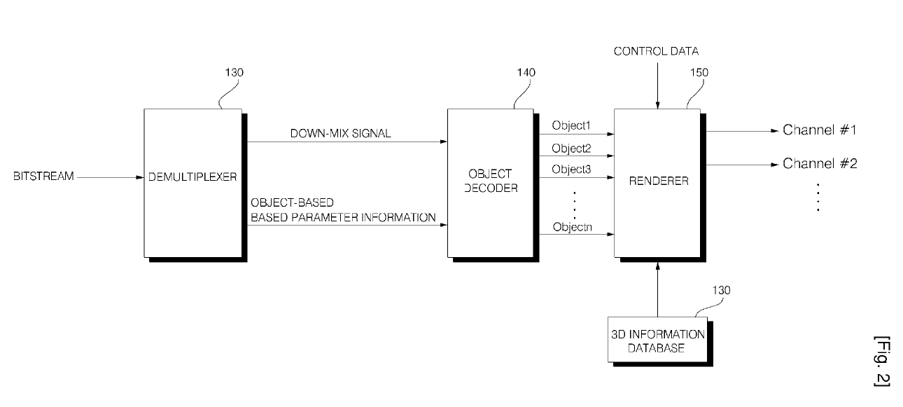

FIG. 2 illustrates an apparatus for decoding an audio signal according to an embodiment of the present invention. The apparatus illustrated in FIG. 2 may be designed by combining the concept of HRTF-based 3D binaural localization to a typical object-based encoding method. A HRTF is a transfer function which describes the transmission of sound waves between a sound source at an arbitrary location and the eardrum, and returns a value that varies according to the direction and altitude of the sound source. If a signal with no directivity is filtered using the HRTF, the signal may be heard as if it were reproduced from a certain direction.

Referring to FIG. 2, the apparatus includes a demultiplexer 130, an object decoder 140, a renderer 150, and a 3D information database 160.

The demultiplexer 130 extracts a down-mix signal and object-based parameter information from an input bitstream. The object decoder 140 generates an object audio signal based on the down-mix signal and the object-based parameter information. The 3D information database 160 is a database which stores 3D information such as an HRTF, and searches for and outputs 3D information corresponding to input index data. The renderer 150 generates a 3D signal using the object audio signal generated by the object decoder 140 and the 3D information output by the 3D information database 160.

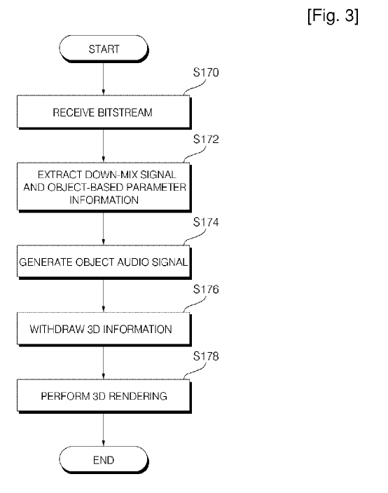

FIG. 3 illustrates an operation of the apparatus illustrated in FIG. 2. Referring to FIGS. 2 and 3, when a bitstream transmitted by an apparatus for encoding an audio signal is received (S170), the demultiplexer 130 extracts a down-mix signal and object-based parameter information from the bitstream (S172). The object decoder 140 generates an object audio signal using the down-mix signal and the object-based parameter information (S174).

The renderer 150 withdraws 3D information from the 3D information database 160 using index data included in control data, which is necessary for designating the positions of object audio signals (S176). The renderer 150 generates a 3D signal with 3D effects by performing a 3D rendering operation using the object audio signal provided by the object decoder 110 and the 3D information provided by the 3D information database 160 (S178).

The 3D signal generated by the renderer 150 may be a 2-channel signal with three or more directivities and can thus be reproduced as a 3D stereo sound by 2-channel speakers such as headphones. In other words, the 3D signal generated by the renderer 150 may be reproduced by 2-channel speakers so that a user can feel as if the 3D down-mix signal were reproduced from a sound source with three or more channels. The direction of a sound source may be determined based on at least one of the difference between the intensities of two sounds respectively input to both ears, the time interval between the two sounds, and the difference between the phases of the two sounds. Therefore, the 3D renderer 150 can generate a 3D signal based on how the humans can determine the 3D position of a sound source with their sense of hearing.

An apparatus for encoding an audio signal may include index data necessary for withdrawing 3D information in default mixing parameter information for default settings. In this case, the renderer 150 may withdraw 3D information from the 3D information database 160 using the index data included in the default mixing parameter information.

An apparatus for encoding an audio signal may include, in control data, index data, which is necessary for searching for 3D information such as an HRTF that can be used to create 3D effects for an object signal. In other words, mixing parameter information included in control data used by an apparatus for encoding an audio signal may include not only level information but also index data necessary for searching for 3D information. The mixing parameter information may be time information such as inter-channel time difference information, position information, or a combination of the level information and the time information.

If there are a plurality of object audio signals and 3D effects need to be added to one or more of the plurality of object audio signals, 3D information corresponding to given index data is searched for and withdrawn from the 3D information database 160, which stores 3D information specifying the target positions of the object audio signals to which the 3D effects are to be added. Then, the 3D renderer 150 performs a 3D rendering operation using the withdrawn 3D information so that the 3D effects can be created. 3D information regarding all object signals may be used as mixing parameter information. If 3D information is applied only to a few object signals, level information and time information regarding object signals, other than the few object signals, may also be used as mixing parameter information.

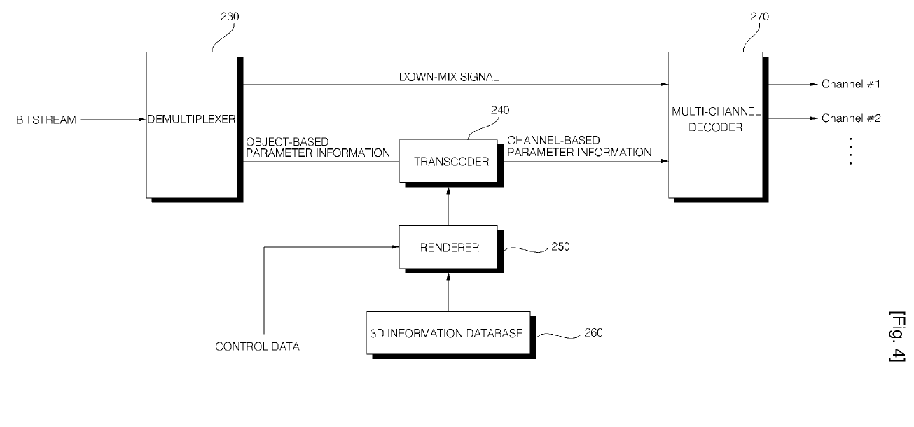

FIG. 4 illustrates an apparatus for decoding an audio signal according to another embodiment of the present invention. Referring to FIG. 4, the apparatus includes a multi-channel decoder 270, instead of an object decoder.

More specifically, the apparatus includes a demultiplexer 230, a transcoder 240, a renderer 250, a 3D information database 260, and the multi-channel decoder 270.

The demultiplexer 230 extracts a down-mix signal and object-based parameter information from an input bitstream. The renderer 250 designates the 3D position of each object signal using 3D information corresponding to index data included in control data. The transcoder 230 generates channel-based parameter information by synthesizing object-based parameter information and 3D position information of each object audio signal provided by the renderer 250. The multi-channel decoder 270 generates a 3D signal using the down-mix signal provided by the demultiplexer 230 and the channel-based parameter information provided by the transcoder 230.

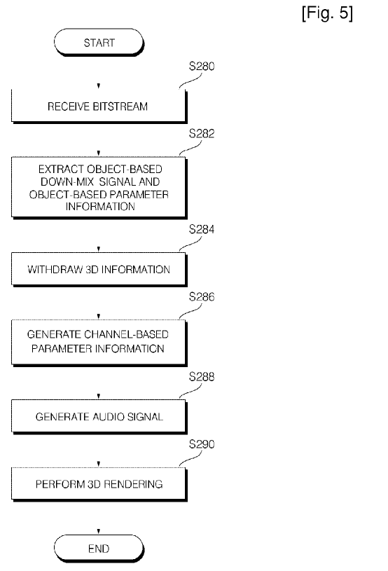

FIG. 5 illustrates an operation of the apparatus illustrated in FIG. 4. Referring to FIGS. 4 and 5, the apparatus receives a bitstream (S280). The demultiplexer 230 extracts an object-based down-mix signal and object-based parameter information from the received bitstream (S282). The renderer 250 extracts index data included in control data, which is used to designate the positions of object audio signals, and withdraws 3D information corresponding to the index data from the 3D information database 260 (S284). The positions of the object audio signals primarily designated by default mixing parameter information may be altered by designating 3D information corresponding to desired positions of the object audio signals using mixing control data.

The transcoder 230 generates channel-based parameter information regarding M channels by synthesizing object-based parameter information regarding N object signals, which is transmitted by an apparatus for encoding an audio signal, and 3D position information of each of the object signals, which is obtained using 3D information such as an HRTF by the renderer 250 (S286).

The multi-channel decoder 270 generates an audio signal using the object-based down-mix signal provided by the demultiplexer 230 and the channel-based parameter information provided by the transcoder 230, and generates a multi-channel signal by performing a 3D rendering operation on the audio signal using 3D information included in the channel-based parameter information (S290).

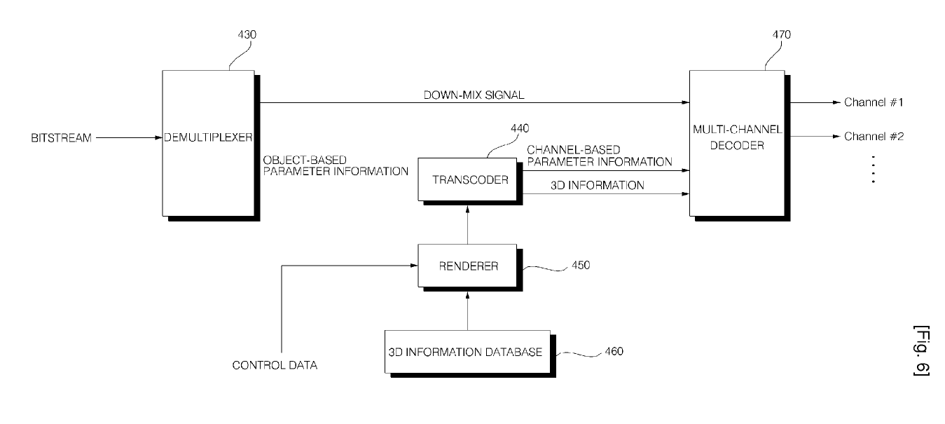

FIG. 6 illustrates an apparatus for decoding an audio signal according to another embodiment of the present invention. The apparatus illustrated in FIG. 6 is different from the apparatus illustrated in FIG. 4 in that a transcoder 440 transmits channel-based parameter information and 3D information separately to a multi-channel decoder 470. In other words, the transcoder 440, unlike the transcoder 240 illustrated in FIG. 4, transmits channel-based parameter information regarding M channels, which is obtained using object-based parameter information regarding N object signals, and 3D information, which is applied to each of the N object signals, to the multi-channel decoder 470, instead of transmitting channel-based parameter information including 3D information.

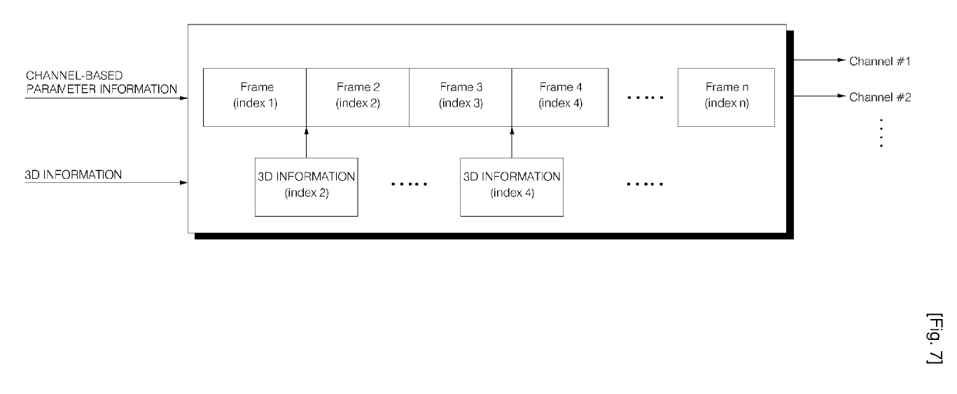

Referring to FIG. 7, channel-based parameter information and 3D information have their own frame index data. Thus, the multi-channel decoder 470 can apply 3D information to a predetermined frame of a bitstream by synchronizing the channel-based parameter information and the 3D information using the frame indexes of the channel-based parameter information and the 3D information. For example, referring to FIG. 7, 3D information corresponding to index 2 can be applied to the beginning of frame 2 having index 2.

Even if 3D information is updated over time, it is possible to determine where in channel-based parameter information the 3D information needs to be applied to by referencing a frame index of the 3D information. In other words, the transcoder 440 may insert frame index information into channel-based parameter information and 3D information, respectively, in order for the multi-channel decoder 470 to temporally synchronize the channel-based parameter information and the 3D information.

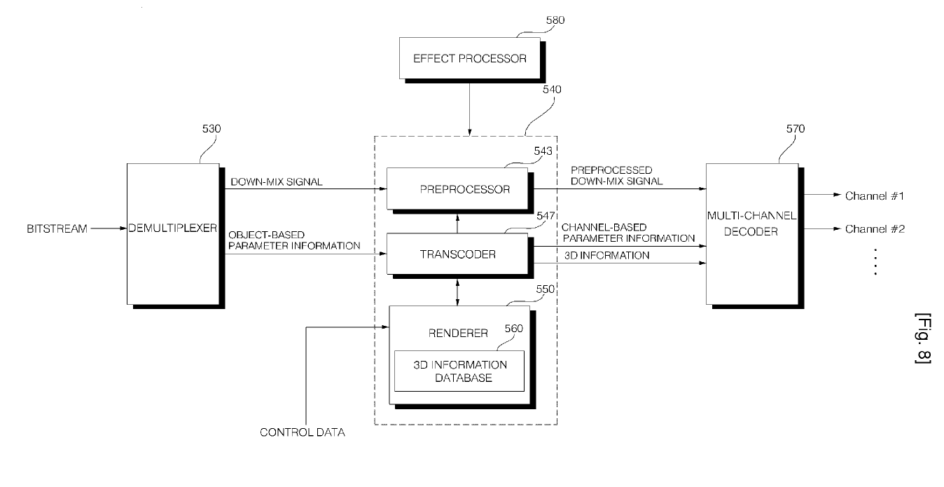

FIG. 8 illustrates an apparatus for decoding an audio signal according to another embodiment of the present invention. The apparatus illustrated in FIG. 8 is different from the apparatus illustrated in FIG. 6 in that the apparatus illustrated in FIG. 8 further includes a preprocessor 543 and an effect processor 580 in addition to a de-multiplexer 530, a transcoder 547, a renderer 550, and a 3D information database 560, and that the 3D information database 560 is included in the renderer 550.

More specifically, the structures and operations of the demultiplexer 530, the transcoder 547, the renderer 560, the 3D information database 560, and the multi-channel decoder 570 are the same as the structures and operations of their respective counterparts illustrated in FIG. 6. Referring to FIG. 8, the effect processor 580 may add a predetermined effect to a down-mix signal. The preprocessor 543 may perform a preprocessing operation on, for example, a stereo down-mix signal, so that the position of the stereo down-mix signal can be adjusted. The 3D information database 560 may be included in the renderer 550.

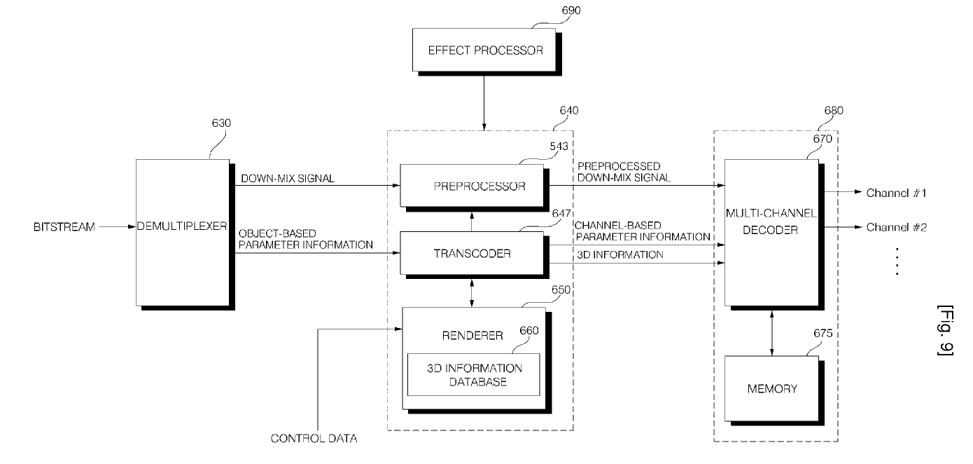

FIG. 9 illustrates an apparatus for decoding an audio signal according to another embodiment of the present invention. The apparatus illustrated in FIG. 9 is different from the apparatus illustrated in FIG. 8 in that a unit 680 for generating a 3D signal is divided into a multi-channel decoder 670 and a memory 675. Referring to FIG. 9, the multi-channel decoder 670 copies 3D information, which is stored in an inactive memory of the multi-channel decoder 670, to the memory 675, and the memory 675 performs a 3D rendering operation using the 3D information. The 3D information copied to the memory 675 may be updated with 3D information output by a transcoder 647. Therefore, it is possible to generate a 3D signal using desired 3D information without any modifications to the structure of multi-channel decoder 670.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

Other implementations are within the scope of the following claims.

### INDUSTRIAL APPLICABILITY

The present invention can be applied to various object-based audio decoding processes and can provide a vivid sense of reality during the reproduction of object audio signals by localizing a sound image for each of the object-audio signals.

1. A method of decoding an audio signal, comprising:
extracting a down-mix signal and object-based parameter information from an input audio signal;
generating an object-audio signal using the down-mix signal and the object-based parameter information; and
generating an object audio signal with three-dimensional (3D) effects by applying 3D information to the object audio signal.

2. The method of claim 1, wherein the 3D information is head related transfer function (HRTF) information.

3. The method of claim 1, further comprising storing the 3D information in a database.

4. The method of claim 1, wherein the 3D information corresponds to index data which is included in control data that is used to render the object audio signal.

5. The method of claim 4, wherein the control data comprises at least one of inter-channel level information, inter-channel time information, position information, and a combination of the inter-channel level information and the time information.

6. The method of claim 4, further comprising rendering the object-audio signal using the control data.

7. The method of claim 1, wherein the index data is included in default mixing parameter information, which is included in the object-based parameter information.

8. An apparatus for decoding an audio signal, comprising:
a demultiplexer which extracts a down-mix signal and object-based parameter information from an input audio signal;
an object decoder which generates an object-audio signal using the down-mix signal and the object-based parameter information; and
a renderer which generates a three-dimensional object audio signal with 3D effects by applying 3D information to the object audio signal.

9. The apparatus of claim 8, further comprising a 3D information database which stores the 3D information.

10. The apparatus of claim 8, wherein the 3D information is head related transfer function (HRTF) information.

11. The apparatus of claim 8, wherein the 3D information corresponds to index data which is included in control data that is used to render the object audio signal.

12. The apparatus of claim 11, wherein the control data comprises at least one of inter-channel level information, inter-channel time information, position information, and a combination of the inter-channel level information and the time information.

13. A method of decoding an audio signal, comprising:
extracting a down-mix signal and object-based parameter information from an input audio signal;
generating channel-based parameter information by converting the object-based parameter information; and
generating an audio signal using the down-mix signal and the channel-based parameter information and generating an audio signal with 3D effects by applying 3D information to the audio signal.

14. The method of claim 13, further comprising storing the 3D information in a database.

15. The method of claim 13, wherein the 3D information is HRTF information.

16. The method of claim 13, wherein the 3D information corresponds to index data which is included in control data that is used to render the object audio signal.

17. The method of claim 16, wherein the control data comprises at least one of inter-channel level information, inter-channel time information, position information, and a combination of the inter-channel level information and the time information.

18. The method of claim 16, further comprising rendering the object-audio signal using the control data.

19. The method of claim 13, further comprising adding a predetermined effect to the down-mix signal.

20. An apparatus for decoding an audio signal, comprising:
a demultiplexer which extracts a down-mix signal and object-based parameter information from an input audio signal;
a renderer which withdraws 3D information using index data and outputs the 3D information;
a transcoder which generates channel-based parameter information using the object-based parameter information and the 3D information; and
a multi-channel decoder which generates an audio signal using the down-mix signal and the channel-based parameter information and generates an audio signal with 3D effects by applying 3D information to the audio signal.

21. The apparatus of claim 20, further comprising a 3D information database which stores the 3D information.

22. The apparatus of claim 20, wherein the 3D information database is included in the renderer.

23. The apparatus of claim 20, further comprising an effect processor which adds a predetermined effect to the down-mix signal.

24. The apparatus of claim 20, wherein the index data is included in control data which is used to render the object audio signal.

25. The apparatus of claim 24, wherein the control data comprises at least one of inter-channel level information, inter-channel time information, position information, and a combination of the inter-channel level information and the time information.

26. An apparatus for decoding an audio signal, comprising:
a demultiplexer which extracts a down-mix signal and object-based parameter information from an input audio signal;
a renderer which withdraws 3D information using input index data and outputs the 3D information;
a transcoder which converts the object-based parameter information into channel-based parameter information, converts the 3D information into channel-based 3D information and outputs the channel-based parameter information and the channel-based 3D information; and
a multi-channel decoder which generates an audio signal using the down-mix signal and the channel-based parameter information and generates an audio signal with 3D effects by applying the channel-based 3D information to the audio signal.

27. The apparatus of claim 26, wherein the multi-channel decoder comprises a memory which stores 3D information commonly used to generate an audio signal with the 3D effects.

28. The apparatus of claim 27, wherein the 3D information stored in the memory is updated with the channel-based 3D information.

29. The apparatus of claim 26, wherein the index data is included in mixing control data which is used to render the object audio signal.

30. The apparatus of claim 26, wherein the channel-based parameter information and the channel-based 3D information comprise index information for synchronizing the channel-based parameter information with the channel-based 3D information.

31. A method of encoding an audio signal, comprising:
generating a down-mix signal by down-mixing an object audio signal;
extracting information regarding the object audio signal and generating object-based parameter information based on the extracted information; and
inserting index data into the object-based parameter information, the index data being necessary for searching for 3D information which is used to create 3D effects for the object audio signal.

32. The method of claim 31, further comprising generating a bitstream by combining the object-based down-mix signal and the object-based parameter information with the index data inserted thereinto.

33. The method of claim 31, wherein the 3D information is HRTF information.

34. A computer-readable recording medium having recorded thereon a program for executing the method of any one of claims 1 through 7.

35. A computer-readable recording medium having recorded thereon a program for executing the method of any one of claims 1 through 7.
